(19) United States
(12) Patent Application Publication
(10) Pub. No.: US 2016/0045893 A1
(43) Pub. Date: Feb. 18, 2016

(54) ADSORBENT, METHOD OF MANUFACTURING ADSORBENT, AND ADSORPTION-TYPE HEAT PUMP

(71) Applicant: FUJITSU LIMITED, Kawasaki-shi (JP)

(72) Inventors: Toshio MANABE, Atsugi (JP); Yoshihiko Imanaka, Atsugi (JP)

(73) Assignee: FUJITSU LIMITED, Kawasaki-shi (JP)

(21) Appl. No.: 14/822,006

(22) Filed: Aug. 10, 2015

(30) Foreign Application Priority Data
Aug. 14, 2014 (JP) 2014-165078

(51) Int. Cl. B01J 20/26; B01J 20/20; B01J 20/32; F25B 30/04

(52) U.S. Cl. CPC B01J 20/262; F25B 30/04; B01J 20/20; B01J 20/3204

(57) ABSTRACT

An adsorbent includes: activated carbon; and a hydrophilic polymer coated on an outer surface of the activated carbon.

And an adsorption-type heat pump includes: an evaporator configured to evaporate a liquid adsorbate to form a gas adsorbate; a condenser connected to the evaporator to condense a gas adsorbate to form a liquid adsorbate; and two adsorbers connected to the evaporator and the condenser, each adsorber including an adsorbent to adsorb/desorb the adsorbate, wherein the adsorbent includes: activated carbon; and a hydrophilic polymer coated on an outer surface of the activated carbon.

### CROSS-REFERENCE TO RELATED APPLICATION

This application is based upon and claims the benefit of priority of the prior Japanese Patent Application No. 2014-165078 filed on Aug. 14, 2014, the entire contents of which are incorporated herein by reference.

### FIELD

The embodiments discussed herein are related to an adsorbent, a method of manufacturing the adsorbent, and an adsorption-type heat pump.

### BACKGROUND

The importance of technical development has rapidly increased recently for reducing the environmental loads such as, for example, prevention of global warming or conservation of energy resources, has rapidly increased recently. Among them, technologies for recovering and reutilizing waste heat discarded in the past due to the lack of usefulness are receiving attention. One of such technologies is an adsorption-type heat pump.

The adsorption-type heat pump utilizes a technology that converts low grade thermal energy of 100° C. or less into useful cold heat using the movement of latent heat generated when an adsorbate such as, for example, water or methanol, is adsorbed to/desorbed from an adsorbent such as, for example, silica gel or activated carbon.

Many studies have been conducted on warm heat required for desorption since around 1978 because some adsorbents are capable of performing desorption even at a relatively low temperature of about 60° C. and thus, recovering energy from various low temperature waste heats.

What is requested to realize an adsorption-type heat pump having a high energy recovery efficiency is an adsorbent that performs desorption at a lower waste heat temperature (e.g., 50° C. to 60° C.) and performs adsorption at a higher cooling water temperature (e.g., 25° C. to 30° C.). This corresponds to a case where an adsorption/desorption reaction progresses in a relative vapor pressure range of about 0.2 to 0.6 in an adsorption isotherm.

Silica gel and zeolite, which are currently frequently used as an adsorbent of an adsorption-type heat pump, easily adsorb water even at high temperature but hardly desorb the water because they have a hydrophilic surface. This means that the adsorption amount is relatively high even if the relative vapor pressure is below 0.2, and the variation of the adsorption amount is small within the aforementioned relative vapor pressure range.

Thus, besides the aforementioned adsorbents, activated carbon has been considered as an adsorbent. The activated carbon having a hydrophobic surface is excellent in desorption performance at a low temperature, and the adsorption amount of the activated carbon at a low relative vapor pressure becomes substantially zero (0). In addition, the activated carbon has an advantage in that a large difference in adsorption amount may be taken because the vertical rise of an adsorption isotherm is steep. On the other hand, the activated carbon has a problem in that a target performance may not be obtained when the cooling water temperature is high because the adsorption/desorption reaction progresses beyond a relative vapor pressure of 0.6 when the activated carbon is laid as it is.

Meanwhile, activated carbon is also used for a filter that filters, for example, chemicals and impurities, without being limited to the use for adsorption-type heat pump. In some cases, an attempt for imparting hydrophilicity is performed on activated carbon for filter in order to modify the activated carbon.

However, imparting the hydrophilicity to an activated carbon for filter cannot be regarded as an optimal modification when the activated carbon is used as an adsorbent for an adsorption-type heat pump.

Therefore, even if a technology for imparting the hydrophilicity to the activated carbon for filter is applied to an adsorbent for the adsorption-type heat pump, an adsorbent for adsorption-type heat pump having energy recovery efficiency may not be obtained.

Accordingly, what is currently requested is to provide an adsorbent for an adsorption-type heat pump having high energy recovery efficiency, a method of manufacturing the adsorbent, and an adsorption-type heat pump having high energy recovery efficiency.

The followings are reference documents.

[Document 1] Japanese Laid-Open Patent Publication No. 2000-219507,

[Document 2] Japanese Laid-Open Patent Publication No. 2001-129393,

[Document 3] Japanese Laid-Open Patent Publication No. 2003-261314, and

[Document 4] T. Ohba et al. “Structures and Stability of Water Nanoclusters in Hydrophobic Nanospaces”, NANO LETTERS 2005 Vol.5 No.2 227-230.

### SUMMARY

According to an aspect of the invention, an adsorbent includes: activated carbon; and a hydrophilic polymer coated on an outer surface of the activated carbon.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic view illustrating a state in which hydrophilic chemical species are adsorbed to activated carbon pores;

FIG. 2 is a schematic view illustrating an exemplary adsorption-type heat pump;

FIG. 3 is a scanning electron microscope (SEM) photograph of an adsorbent for an adsorption-type heat pump of Example 2;

FIG. 4 illustrates vapor adsorption isotherms of adsorbents for an adsorption-type heat pump of Examples 1 and 2 and Comparative Examples 1 to 3; and

FIG. 5 illustrates vapor adsorption isotherms of adsorbents for an adsorption-type heat pump of Example 3 and Comparative Examples 4 and 5.

### DESCRIPTION OF EMBODIMENTS

(Adsorbent for Adsorption-Type Heat Pump)

An adsorbent for an adsorption-type heat pump disclosed herein includes at least activated carbon and a hydrophilic polymer film, and may further include other components as needed.

In the adsorbent for the adsorption-type heat pump, the hydrophilic polymer film is present on the outer surface of the activated carbon.

The adsorbents that adsorb water include those having a hydrophilic surface that directly interacts with water molecules and those using a mechanism in which a hydrophobic surface causes water molecules to condense in pores. The former includes, for example, silica gel and polymer sorbents, and the latter includes activated carbon. Both the former and the latter have greatly different adsorption characteristics. The former performs adsorption even at a low relative vapor pressure, but has a small difference in adsorption amount in a narrow vapor pressure range. The latter exhibits a rapid reaction and a large difference in adsorption amount, but hardly performs adsorption when a relative vapor pressure is low. Thus, an adsorbent compounded to utilize the advantages of both the former and the latter and suppress an effect on pore structure or pore volume may be required.

The inventors of the present disclosure have found a structure in which a hydrophilic polymer film is attached to a hydrophobic surface of activated carbon particles. It has been revealed that the adsorption of water to hydrophobic activated carbon progresses as water molecules are clustered in micro spaces of pores to be entirely reduced in polarity and thus, increasingly interact with a wall surface.

In addition, the introduction of hydrophilic chemical species into pores has an effect of causing the adsorption reaction of water to be initiated from a low relative vapor pressure by making the chemical species serve as a clustering core.

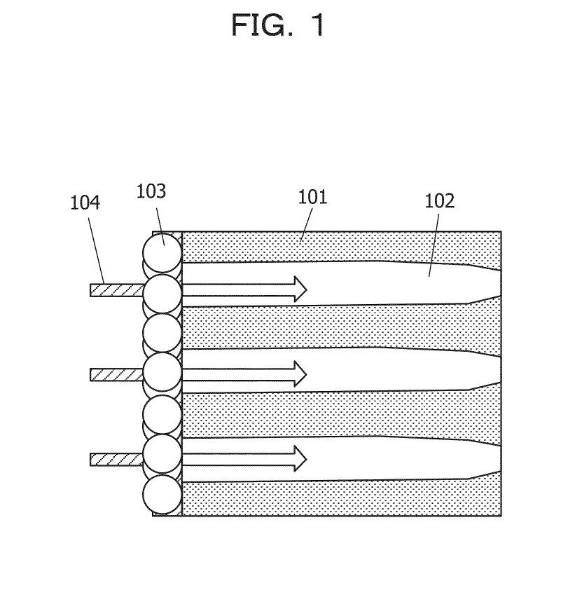

Accordingly, as illustrated in FIG. 1, it is considered that, when the openings of pores 102 of activated carbon 101 are coated with a hydrophilic polymer 103, the clustering of water is facilitated in the vicinity of the coated openings and thus, the adsorption of hydrophilic chemical species 104 to the inside of the pores 102 of the activated carbon 101 easily progresses. Thus, it is considered that the adsorption performance may be improved without having an effect on the pore structure or the pore volume.

(Activated Carbon)

The activated carbon may be appropriately selected according to a purpose without being particularly limited.

The specific surface area of the activated carbon may be appropriately selected according to a purpose without being particularly limited, but the specific surface area may be in a range of 1,000 m²/g to 2,500 m²/g, or in a range of 1,200 m²/g to 2,000 m²/g. When the specific surface area is in the range of 1,200 m²/g to 2,000 m²/g, it is advantageous in that a high performance adsorbent for adsorption-type heat pump, of which the adsorption/desorption reaction progresses at a relative vapor pressure in a range of 0.33 to 0.65 in the adsorption isotherm, may be obtained.

The specific surface area may be calculated by measuring a nitrogen adsorption isotherm using, for example, a specific surface area/pore distribution measuring device (BELSORP-mini manufactured by BEL JAPAN, INC,), and analyzing the nitrogen adsorption isotherm by the BET method.

The activated carbon may be either a manufactured activated carbon or a commercially available activated carbon. The commercially available activated carbon may be, for example, Spherical Activated Carbon Taikou Q Type (manufactured by Futamura Chemical Co., Ltd.) or Kureha Spherical Activated Carbon BAC (manufactured by Kureha Corporation).

(Hydrophilic Polymer Film)

The hydrophilic polymer film is present on the outer surface of the activated carbon.

The hydrophilic polymer film is present on the outer surface of the activated carbon, but is not present in the pores of the activated carbon.

In the adsorbent for adsorption-type heat pump, even if the hydrophilic polymer film is present on the outer surface of the activated carbon, small molecules such as, for example, water molecules are capable of penetrating the film from gaps between molecules in the film to enter the pores of the activated carbon.

The hydrophilic polymer film thickness may be appropriately selected according to a purpose without being particularly limited.

<<Hydrophilic Polymer>>

The hydrophilic polymer is a polymer having a hydrophilic functional group, and due to the presence of the hydrophilic functional group, may be a polymer that enables adsorption of water even at a low relative vapor pressure (e.g., 0.3) in the adsorbent for adsorption-type heat pump.

The hydrophilic functional group may be, for example, an amino group, a carbonyl group, a carboxyl group, a hydroxyl group, an amide group, a quaternary ammonium group, or a carboxylate group.

The amount of the hydrophilic functional group in the hydrophilic polymer may be appropriately selected according to a purpose without being particularly limited, but may be within a range of 3 meq/g to 12 meq/g.

In the measurement of the amount of the hydrophilic functional group, for example, a sample may be dipped in a 0.1 N sodium hydrogen carbonate solution, a 0.1 N sodium carbonate solution, or a 0.1 N sodium hydroxide solution, and a supernatant liquid may be back titrated with 0.1 N hydrochloric acid so as to quantitatively determine a carboxyl group, a lactone group, or a phenolic hydroxyl group corresponding to the respective solutions.

The hydrophilic polymer may be appropriately selected according to a purpose without being particularly limited, but may be a water-soluble silica-based polymer or an acrylic acid-based polymer in view of hydrophilicity level and ease of preparation.

The water-soluble silica-based polymer may be, for example, a polysiloxane having a hydrophilic functional group. The polysiloxane having a hydrophilic functional group may be, for example, a polymer of alkoxysilane having a hydrophilic functional group.

The alkoxysilane having a hydrophilic functional group may be, for example, an alkoxysilane having an amino group. The alkoxysilane having an amino group may be, for example, 3-aminopropyltrimethoxysilane or 3-aminopropyltriethoxysilane.

Here, for example, when 1 g of a polymer is mixed and agitated with 100 g of water at 25° C., if the polymer is dissolved in the water and the resulting aqueous solution is transparent, it may be said that the polymer is water-soluble.

The acrylic acid-based polymer may be, for example, a polyacrylic acid, polyacrylic acid sodium, or poly (N-isopropylacrylamide). They may be cross-linked structures. The acrylic acid-based polymer may be either a synthesized polymer or a commercially available product. The commercially available product may be, for example, HU-750P (manufactured by Japan Exlan Co., Ltd.), Aronvis (manufactured by Toagosei Co., Ltd.), or Rheozick (manufactured by Toagosei Co., Ltd.).

The activated carbon may be coated with the hydrophilic polymer.

The content of the hydrophilic polymer in the adsorbent for adsorption- type heat pump may be appropriately selected according to a purpose without being particularly limited, but may be 3 mass % to 50 mass %. With the content of this range, small molecules such as, for example, water molecules are capable of penetrating the film from gaps between molecules in the hydrophilic polymer film, and sufficiently entering the pores of the activated carbon.

A method for manufacturing the above-mentioned adsorbent for adsorption-type heat pump may be appropriately selected according to a purpose without being particularly limited, but a method of manufacturing an adsorbent for adsorption-type heat pump as described below may be selected.

(Method for Manufacturing Adsorbent for Adsorption-Type Heat Pump)

A method for manufacturing an adsorbent for adsorption-type heat pump disclosed herein includes a dipping process. The disclosed method may include an acid treatment process, and may further include other processes as needed.

The method for manufacturing an adsorbent for adsorption-type heat pump is a method for manufacturing above mentioned adsorbent for adsorption-type heat pump as disclosed herein.

(Dipping Process)

The dipping process may be appropriately selected according to a purpose without being particularly limited so long as it is a process of dipping activated carbon in a solution containing a hydrophilic polymer.

The activated carbon may be, for example, the activated carbon exemplified in the description of the adsorbent for adsorption-type heat pump disclosed herein.

The hydrophilic polymer may be, for example, the hydrophilic polymer exemplified in the description of the adsorbent for adsorption-type heat pump, but may be a water-soluble silica-based polymer.

The content of the hydrophilic polymer in the solution may be appropriately selected according to a purpose without being particularly limited, but may be, for example, in a range of 10 mass % to 50 mass %.

A solvent used for the solution may be appropriately selected according to a purpose without being particularly limited, but may be water. That is, the solution may be an aqueous solution.

In the dipping, the amount of the activated carbon in relation to the solution may be appropriately selected according to a purpose without being particularly limited.

The dipping time may be appropriately selected according to a purpose without being particularly limited, but may be in a range of 1 hour to 48 hours, in a range of 2 hours to 24 hours, or in a range of 6 hours to 18 hours.

The temperature of the solution in the dipping may be appropriately selected according to a purpose without being particularly limited, but may be in a range of 10° C. to 50° C., or in a range of 20° C. to 40° C.

(Acid Treatment Process)

The acid treatment process may be appropriately selected according to a purpose without being particularly limited so long as it is a process for treating the activated carbon with an acid prior to the dipping process. For example, a method of dipping the activated carbon in the acid may be exemplified.

The acid may be, for example, a nitric acid or a mixed acid. The mixed acid may be, for example, an acid obtained by mixing concentrated sulfuric acid and concentrated nitric acid in a volume ratio (concentrated sulfuric acid:concentrated nitric acid) of 3:1.

The time for dipping the activated carbon in the acid may be appropriately selected according to a purpose without being particularly limited, but may be in a range of 0.1 hours to 3 hours, or in a range of 0.5 hours to 2 hours.

The surface of the activated carbon may be made hydrophilic by treating the activated carbon with the acid. The amount of a carboxyl group on the hydrophilic surface of the activated carbon may be in a range of 1 mmol/m² to 2 mmol/m².

When using the method for manufacturing the adsorbent for adsorption-type heat pump, a hydrophilic polymer may be coated on a surface of hydrophobic activated carbon in the form of a film. In particular, a water-soluble silica-based polymer may be coated on the surface of the activated carbon in the form of a film.

Conventional silica gel is solidified when it is synthesized by the sol gel method. Thus, the conventional silica gel is hardly fixed to be thin on the surface of the activated carbon.

Meanwhile, some kinds of silica-based polymers are known to have a nature of being dissolved in water (NewGlass 76 Vol, 20 No. 1 (2005)). Thus, when using the method for manufacturing an adsorbent for adsorption-type heat pump as disclosed herein, a state where a silica-based polymer is fixed to surfaces of activated carbon particles may be obtained by dipping activated carbon particles in a solution of the silica-based polymers and concentrating the same.

When using hydrophobic activated carbon as it is, the hydrophilicity of the activated carbon may be increased in advance since a fixing force obtained with the hydrophilic polymer and the hydrophobic activated carbon is weak. Then, the hydrophilic polymer may be efficiently coated over the outer surface of the activated carbon through the interaction between the hydrophilic functional group of the activated carbon and the hydrophilic functional group of the hydrophilic polymer.

(Adsorption-Type Heat Pump)

The adsorption-type heat pump disclosed herein includes at least an adsorbent for adsorption-type heat pump which is disclosed herein and may further include other means as needed.

Descriptions will be made on an example of the disclosed adsorption-type heat pump with reference to the drawings.

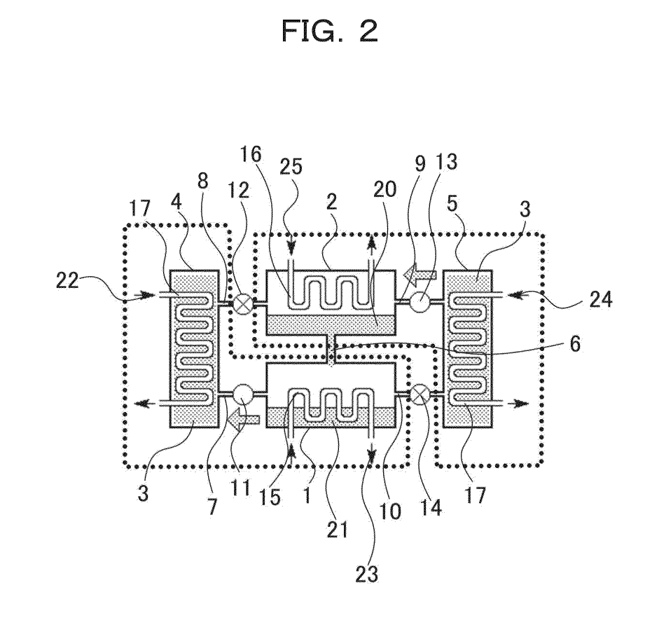

As illustrated in FIG. 2, the adsorption-type heat pump disclosed herein includes an evaporator 1 that evaporates a liquid adsorbate into a gas adsorbate, a condenser 2 that condenses a gas adsorbate into a liquid adsorbate, and two adsorbers 4 and 5 each having an adsorbent for adsorption-type heat pump 3 capable of adsorbing/desorbing an adsorbate.

The evaporator 1 and the condenser 2 are connected to each other via a first flow path 6. In addition, one adsorber 4 is connected to one side of the evaporator 1 and the condenser 2 (i.e. the left side in FIG. 2). That is, one side of the evaporator 1 and one adsorber 4 are connected to each other via a second flow path 7, and one side of the condenser 2 and the one adsorber 4 are connected to each other via a third flow path 8. In addition, the other adsorber 5 is connected to the other side of the evaporator 1 and the condenser 2 (the right side in FIG. 2). That is, the other side of the condenser 2 and the other adsorber 5 are connected to each other via a fourth flow path 9 and the other side of the evaporator 1 and the other adsorber 5 are connected to each other via a fifth flow path 10. In addition, the second flow path 7, the third flow path 8, the fourth flow path 9, and the fifth flow path 10 are respectively provided with valves 11 to 14 that perform opening/closing of the respective flow paths. Further, each of the evaporator 1, the condenser 2, the adsorbers 4 and 5, and the respective flow paths 6 to 10 has a hermetically sealed space therein which is typically in a decompressed state while the adsorption-type heat pump is used.

Here, the evaporator 1 cause the phase change of a liquid adsorbate 21 to a gas adsorbate, and includes a heat exchanger to extract cold heat 23. The evaporator 1 includes a tubular member 15 that causes a fluid, which is capable of transferring the cold heat 23 generated during evaporation of the liquid adsorbate 21 to the outside, to flow therein as a heat transfer medium. In the evaporator 1, the gas adsorbate is adsorbed by one adsorber (the adsorber 4 in FIG. 2) in the process of adsorption. As the gas adsorbate is discharged from the evaporator 1 to the one adsorber 4 through the flow path (the second flow path 7 in FIG. 2), the liquid adsorbate 21 is evaporated. Then, the cold heat 23 generated during the evaporation of the liquid adsorbate 21 is transferred to the outside by the fluid serving as the heat transfer medium flowing through the inside of the tubular member 15 so that the cold heat 23 is used for cooling, for example.

The condenser 2 is a heat exchanger that cools the gas adsorbate to cause phase change of the gas adsorbate to a liquid adsorbate 20. The condenser 2 includes a tubular member 16 that causes a fluid having a lower temperature than a condensation point of the adsorbate (here, cooling water 25) to flow therein as a heat transfer medium. In the process of desorption, the condenser 2 cools the gas adsorbate introduced from one adsorber (the adsorber 5 in FIG. 2) through the flow path (the fourth flow path 9 in FIG. 2) so as to cause the phase change of the gas adsorbate to the liquid adsorbate 20. Then, the liquid adsorbate 20 is sent from the condenser 2 to the evaporator 1 through the first flow path 6. The adsorbate is, for example, water. As for the adsorbate, alcohol such as, for example, methanol or ethanol, may be used.

Each of the adsorbers 4 and 5 includes a tubular member 17 that allows a fluid to flow therein. The adsorbers 4 and 5 are heat exchangers filled with the adsorbent for adsorption-type heat pump 3 around the tubular member 17.

Here, in the adsorbent for adsorption-type heat pump 3, the desorption of the adsorbate predominantly occurs at a specific or higher temperature and the adsorption predominantly occurs below the specific temperature.

Therefore, the temperature of the adsorbent for adsorption-type heat pump 3 is controlled by the temperature of the fluid flowing in the tubular member 17 so that the desorption or adsorption of the adsorbate is controlled.

That is, in the adsorption process of adsorbing the adsorbate to the adsorbent for adsorption-type heat pump 3 provided in the adsorbers 4 and 5, the fluid serving as a heat transfer medium capable of controlling the adsorbent 3 to be at the temperature where the adsorption of the adsorbate predominantly occurs, flows in the tubular member 17. Here, the cooling water 22 medium flows as the heat transfer so as to cool the adsorbent for adsorption-type heat pump 3 so that the adsorbate is adsorbed by the adsorbent for adsorption-type heat pump 3.

Meanwhile, in the desorption process of desorbing the adsorbate from the adsorbent for adsorption-type heat pump 3 in the adsorbers 4 and 5, the fluid serving as a heat transfer medium capable of controlling the adsorbent for adsorption-type heat pump 3 to be at the temperature where desorption of the adsorbate predominantly occurs, flows in the tubular member 17. Here, the temperature required for desorbing the adsorbate from the adsorbent for adsorption-type heat pump 3 is about 60° C. Therefore, relatively low temperature waste heat of about 100° C. or less is used as warm heat. That is, the warm heat recovered from, for example, waste heat is transferred by the fluid serving as the heat transfer medium and the adsorbent for adsorption-type heat pump 3 is heated so that the adsorbate is desorbed from the adsorbent for adsorption-type heat pump 3.

The adsorption-type heat pump configured as described above may continuously generate cold heat from the warm heat by switching the opening and closing states of the valves 11 to 14 to repeat the adsorption process and the desorption process.

For example, as illustrated in FIG. 2, in the case where the valves 11 and 13 are opened and the valves 12 and 14 are closed, the one adsorber 4 (the left side in FIG. 2) is connected to the evaporator 1, and the other adsorber 5 (the right side in FIG. 2) is connected to the condenser 2. In this case, the cooling water 22 flows to the one adsorber 4 to cool the adsorbent for adsorption-type heat pump 3, and warm heat 24 recovered from, for example, waste heat is transferred to the other adsorber 5 by the fluid to heat the adsorbent for adsorption-type heat pump 3. In this way, the adsorbate is adsorbed by the adsorbent for adsorption-type heat pump 3 provided in the one adsorber 4, and the adsorbate is desorbed from the adsorbent for adsorption-type heat pump 3 provided in the other adsorber 5. That is, the one adsorber 4 connected to the evaporator 1 is in the adsorption process and the other adsorber 5 connected to the condenser 2 is in the desorption process.

Meanwhile, in the case where the valves 12 and 14 are opened and the valves 11 and 13 are closed, the other adsorber 5 (the right side in FIG. 2) is connected to the evaporator 1 and the one adsorber 4 (the left side in FIG. 2) is connected to the condenser 2. In this case, the cooling water flows to the other adsorber 5 to cool the adsorbent for adsorption-type heat pump 3 and warm heat 24 recovered from, for example, waste heat is transferred to the one adsorber 4 by the fluid to heat the adsorbent for adsorption-type heat pump 3. In this way, the adsorbate is adsorbed by the adsorbent for adsorption-type heat pump 3 provided in the other adsorber 5, and the adsorbate is desorbed from the adsorbent for adsorption-type heat pump 3 provided in the one adsorber 4. That is, the other adsorber 5 connected to the evaporator 1 is in the adsorption process and the one adsorber 4 connected to the condenser 2 is in the desorption process.

In this way, cold heat may be successively generated from warm heat by switching the opening and closing states of the valves 11 to 14 to repeat the adsorption process and the desorption process.

Here, the adsorption process and the desorption process are repeatedly performed by performing the adsorption process of the one adsorber 4 and the desorption process of the other adsorber 5 simultaneously and performing the desorption process of the one adsorber 4 and the adsorption process of the other adsorber 5 simultaneously, but is not limited thereto. For example, the adsorption process and the desorption process may be repeatedly performed by performing the adsorption process of the one adsorber 4 and the adsorption process of the other adsorber 5 simultaneously and performing the desorption process of the one adsorber 4 and the desorption process of the other adsorber 5 simultaneously. That is, the adsorption process and the desorption process may be performed stepwise. In this case, in the adsorption process, the valves 11 and 14 may be opened and the valves 12 and 13 may be closed so as to cause cooling water to flow to both adsorbers 4 and 5, thereby cooling the adsorbent for adsorption-type heat pump 3. Meanwhile, in the desorption process, the valves 12 and 13 may be opened and the valves 11 and 14 may be closed so as to cause warm heat, recovered from, for example, waste heat, to be transferred to both adsorbers 4 and 5 by the fluid, thereby heating the adsorbent for adsorption-type heat pump 3.

### Examples

Hereinafter, an adsorbent for the adsorption-type heat pump and a method of manufacturing the same will be described in detail with reference to examples. However, the adsorbent for the adsorption-type heat pump as disclosed herein and the method of manufacturing the same are not limited by the examples in any way.

In the following examples, a specific surface area and a vapor adsorption isotherm were measured by the following methods.

<Specific Surface Area>

A specific surface area was calculated by measuring a nitrogen adsorption isotherm using a specific surface area/pore distribution measuring device (BELSORP-mini manufactured by BEL JAPAN, INC.) and analyzing the nitrogen adsorption isotherm by BET method. A measured sample was subjected to a pre-treatment in which the sample was heated in vacuum at 150° C. for 3 hours.

<Vapor Adsorption Isotherm>

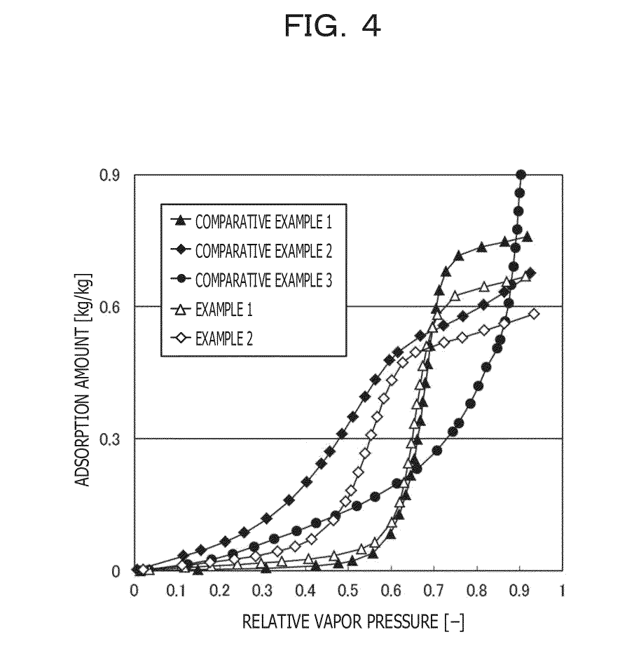

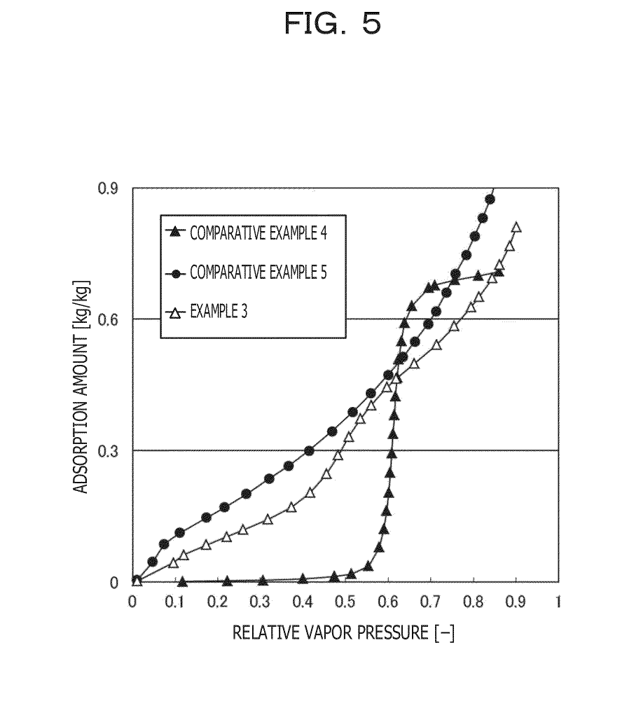

A vapor adsorption isotherm was calculated using an adsorption isotherm measuring device (BELSORP-aqua3 manufactured by BEL JAPAN, INC.) under conditions of: a temperature of an air constant temperature tank of 80° C., an adsorption temperature of 30° C., a saturation vapor pressure of 4.245 kPa, and an equilibration time of 500 seconds. A measured sample was subjected to a pre-treatment in which the sample was heated in vacuum at 150° C. for 3 hours. Results are illustrated in FIGS. 4 and 5.

### Comparative Example 1

As the adsorbent for adsorption-type heat pump of Comparative Example 1, activated carbon (Spherical Activated Carbon TaikouQ Type manufactured by Futamura Chemical Co., Ltd, and having a specific surface area of 2,000 m²/g) was used.

In the adsorbent for adsorption-type heat pump of Comparative Example 1, the difference in adsorption amount Aq in a relative vapor pressure range of 0.33 to 0.65 was 0.23 g/g (FIG. 4).

### Comparative Example 2

A sample was obtained by dipping activated carbon (Spherical Activated Carbon TaikouQ Type manufactured by Futamura Chemical Co., Ltd. and having a specific surface area of 2,000 m²/g) in a mixed acid obtained by mixing concentrated sulfuric acid and concentrated nitric acid in a volume ratio (concentrated sulfuric acid:concentrated nitric acid) of 3:1, for 1 hour, and cleaning and drying the activated carbon. The sample was used as an adsorbent for adsorption-type heat pump of Comparative Example 2.

In the adsorbent for adsorption-type heat pump of Comparative Example 2, the difference in adsorption amount Aq in a relative vapor pressure range of 0.33 to 0.65 was 0.39 g/g (FIG. 4).

### Comparative Example 3

A solid silica-based polymer was obtained by dissolving 4 g of 3-aminopropyltrimethoxysilane in 25 ml of ethanol, adding 10 ml of hydrochloric acid thereto, heating the same at 60° C. for 0.5 hours, and then drying the same in vacuum. The silica-based polymer obtained thereby was used as an adsorbent for adsorption-type heat pump of Comparative Example 3.

In the adsorbent for adsorption-type heat pump of Comparative Example 3, the difference in adsorption amount Aq in a relative vapor pressure range of 0.33 to 0.65 was 0.15 g/g (FIG. 4).

### Comparative Example 4

Powder (average grain size: 10 μm) obtained by crushing activated carbon (Fibrous Activated Carbon FR-20 manufactured by Kuraray Chemical Co., Ltd. and having a specific surface area of 2,000 m²/g) was used as the adsorbent for adsorption-type heat pump of Comparative Example 4.

In the adsorbent for adsorption-type heat pump of Comparative Example 4, the difference in adsorption amount Aq in a relative vapor pressure range of 0.33 to 0.65 was 0.01 g/g (FIG. 5).

### Comparative Example 5

Powder (average grain size: 10 μm) of a polymer sorbent formed of polyacrylic acid sodium (HU-750P manufactured by Japan Exlan Co., Ltd.) was used as the adsorbent for adsorption-type heat pump of Comparative Example 5.

In the adsorbent for adsorption-type heat pump of Comparative Example 5, the difference in adsorption amount Aq in a relative vapor pressure range of 0.27 to 0.48 was 0.15 g/g (FIG. 5).

### Example 1

Activated carbon (Spherical Activated Carbon Taikou Q Type manufactured by Futamura Chemical Co., Ltd. and having a specific surface area of 2,000 m²/g) was coated with a silica-based polymer by dipping 0.3 g of the activated carbon into 5 mL of an aqueous solution (the content of the silica-based polymer: 30 mass %) obtained by dissolving the silica-based polymer synthesized in Comparative Example 3 in water, for 12 hours. Thereafter, an adsorbent for adsorption-type heat pump was obtained by extracting the activated carbon coated with the silica-based polymer and drying the same in vacuum at 150° C. for 2 hours.

The amount (coating amount) of the hydrophilic polymer in the obtained adsorbent for adsorption-type heat pump was 20 mass %.

In the adsorbent for adsorption-type heat pump of Example 1, the difference in adsorption amount Aq in a relative vapor pressure range of 0.33 to 0.65 was 0.29 g/g (FIG. 4). The vertical rise of relative vapor pressure of the vapor adsorption isotherm was lower than that in Comparative Example 1.

### Example 2

Activated carbon was coated with a silica-based polymer by dipping 0.3 g of the sample obtained in Comparative Example 2 in 5 mL of an aqueous solution (content of silica-based polymer: 30 mass %) obtained by dissolving the silica-based polymer obtained in Comparative Example 3 in water, for 12 hours. Thereafter, an adsorbent for adsorption-type heat pump was obtained by extracting the activated carbon coated with the silica-based polymer and drying the same in vacuum at 150° C. for 2 hours.

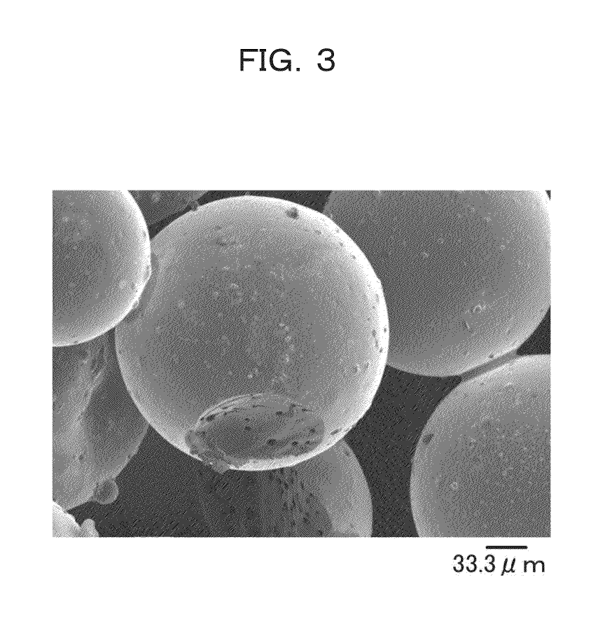

As a result of observing the obtained adsorbent for adsorption-type heat pump using SEM, it has found that the surface of the activated carbon is uniformly coated with the silica-based polymer, as illustrated in FIG. 3.

The amount (coating amount) of the hydrophilic polymer in the obtained adsorbent for adsorption-type heat pump was 33 mass %.

In the adsorbent for adsorption-type heat pump of Example 2, the difference in adsorption amount Aq in a relative vapor pressure range of 0.33 to 0.65 was 0.45 g/g (FIG. 4). The vertical rise of the vapor adsorption isotherm was steeper than that in Comparative Example 2.

### Example 3

Compounded adsorbent particles were obtained by mixing 50 g of activated carbon powder obtained in Comparative Example 4 [powder (average grain size: 10 μm) obtained by crushing the activated carbon (Fibrous Activated Carbon FR-20 manufactured by Kuraray Chemical Co., Ltd. and having a specific surface area of 2,000 m²/g)] and 50 g of the polymer sorption agent of Comparative Example 5 within a surface modifying apparatus (Hybridization System manufactured by Nara Machinery Co., Ltd.) that applies shock by a rotating rotor. The compounded adsorbent particles were used as an adsorbent for adsorption-type heat pump in Example 3.

The amount (coating amount) of the hydrophilic polymer in the obtained adsorbent for adsorption-type heat pump was 10 mass %.

In the adsorbent for adsorption-type heat pump in Example 3, the difference in adsorption amount Aq in a relative vapor pressure range of 0.27 to 0.48 was 0.16 g/g (FIG. 5). This is larger than the difference in adsorption amount Aq in the relative vapor pressure range of 0.27 to 0.48 in each of the adsorbents for adsorption-type heat pump in Comparative Examples 1 and 2.

Example 4

An adsorbent for adsorption-type heat pump was obtained under the same conditions as Example 2 except that the aqueous solution (content of silica-based polymer: 30 mass %) in Example 2 was changed to an aqueous solution in which the concentration of a silica-based polymer was 15 mass %.

The amount (coating amount) of the hydrophilic polymer in the obtained adsorbent for adsorption-type heat pump was 33 mass %.

In the adsorbent for adsorption-type heat pump in Example 4, the difference in adsorption amount Aq in a relative vapor pressure range of 0.33 to 0.65 was 0.45 g/g as in Example 2.

Based on results of the vapor adsorption isotherms of FIGS. 4 and 5, the adsorbents for adsorption-type heat pump in Examples 1 to 4 exhibited a large difference in adsorption amount between a low relative vapor pressure (about 0.3) and a high relative vapor pressure (about 0.6) and an excellent adsorption/desorption characteristic compared with the adsorbents for adsorption-type heat pump in Comparative Examples 1 to 5.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An adsorbent comprising:
activated carbon; and
a hydrophilic polymer coated on an outer surface of the activated carbon.

2. The adsorbent according to claim 1, wherein the hydrophilic polymer is any one of a water-soluble silica-based polymer and an acrylic acid-based polymer.

3. The adsorbent according to claim 2, wherein the water-soluble silica-based polymer is a polymer of alkoxysilane having an amino group.

4. The adsorbent according to claim 3, wherein the alkoxysilane having the amino group is 3-aminopropyltrimethoxysilane.

5. The adsorbent according to claim 2, wherein the acrylic acid-based polymer is any one of polyacrylic acid, polyacrylic acid sodium, and poly(N-isopropylacrylamide).

6. The adsorbent according to claim 2, wherein the acrylic acid-based polymer is polyacrylic acid.

7. The adsorbent according to claim 1, wherein a specific surface area of the activated carbon is in a range of 1,000 m²/g to 2,500 m²/g.

8. A method for manufacturing an adsorbent, comprising:
dipping activated carbon in a solution containing a hydrophilic polymer.

9. The method according to claim 8, wherein the activated carbon is treated with an acid prior to the dipping of the activated carbon in the solution containing the hydrophilic polymer.

10. An adsorption-type heat pump comprising:
an evaporator configured to evaporate a liquid adsorbate to form a gas adsorbate;
a condenser connected to the evaporator to condense a gas adsorbate to form a liquid adsorbate; and
two adsorbers connected to the evaporator and the condenser, each adsorber including an adsorbent to adsorb/desorb the adsorbate,
wherein the adsorbent includes:
activated carbon; and
a hydrophilic polymer coated on an outer surface of the activated carbon.
